(19) United States
(12) Patent Application Publication
(10) Pub. No.: US 2004/0043128 A1
(43) Pub. Date: Mar. 4, 2004

(54) Flaked food material containing soy isolates

(76) Inventors: David K. Duffy, North Mankato, MN (US); Salvador U. Parco JR., Mankato, MN (US)

Correspondence Address: Robert C. Freed, MOORE, HANSEN & SUMNER, 2900 Wells Fargo Center, 90 South Seventh Street, Minneapolis, MN, 55402, US

(21) Appl. No.: 10/435,412

(22) Filed: May 9, 2003

Related U.S. Application Data
(60) Provisional application No. 60/379,578, filed on May 10, 2002.
(60) Provisional application No. 60/388,878, filed on Jun. 14, 2002.

(51) Int. Cl. A21D 2/00

(52) U.S. Cl. 426/622

(57) ABSTRACT

The present invention provides flaked food material products including from about 10 to about 95% by weight of a cereal flour, from about 2 to about 20% by weight of water, and from about 5 to about 50% by weight of a soy protein. In preferred embodiments, the soy protein isolate is at least partially hydrolyzed soy protein in which the soy protein is hydrolyzed either during isolation or subsequent to isolation in further processing of the soy protein isolate. In alternate embodiments, the preferred soy protein isolate will have a viscosity of less than 800, preferably less than 400 CPS at 25° C. at a shear rate of ten seconds on a Brookfield viscosity meter when the concentration of the soy protein isolate in de-ionized water is at least about 8%, preferably about 10%, more preferably about 12% and most preferably about 14%. Oat containing clusters and granola bars containing such flaked food material are also provided.

### BACKGROUND OF THE INVENTION

Flaked cereal products are a staple food item in many sectors of the North American market. These flakes are generally made of wheat, corn, oats and the like, which provide nutritious foodstuffs for consumers. In recent years, flakes of this type have been incorporated into a wider range of food products such as the various bars which are common in certain segments of the North American market. These bars are often promoted as providing a particularly nutritious supplement for people that have an active lifestyle; people that are “on the go” and in need of a nutritious dietary supplement when time for sitting down to a full meal may be in short supply.

Although flaked food material products presently known in the food industry have been well received by consumers, manufacturers are also interested in providing flaked food materials containing a variety of food materials beyond the traditional carbohydrate-based flakes, so that other nutritious food constituents can be provided in such flake products. In particular, many manufacturers would like to provide flaked food material products in bars or other food formulations, which include a larger amount of protein, so that these flakes can be included in such nutritious dietary supplements. In the past, however, providing such products has been problematic because taste and mouthfeel (organoleptic) parameters, which are necessary to provide a desirable product, have not been met when the amount of protein is increased. Furthermore, in the extrusion process, the inclusion of protein in a relatively large amount can have adverse effects upon the extrusion processing. In particular, it has been noted that the inclusion of as little as about 10 to 20% high protein food materials in the formulation can cause a significant increase in the torque, which must be applied to the food material in the extruder. This increase in torque may cause a shutdown of an extrusion process line used to make the product, creating product production delays, product losses and increased labor expenses associated with production when the systems shut down. This is because each extruder has a torque rating based upon the horsepower the drive mechanism can generate. Modern extruders are generally equipped with sensing mechanisms that sense the torque that is being applied and most of these extruders will shut down when the torque exceeds the torque rating established for that particular extruder. It will be appreciated that efforts to minimize the risk of such a shutdown will provide production efficiencies that will lower the overall expense associated with the production of any such product.

It will be further appreciated that it would be desirable to provide a food material formulation that provides a flaked food material product which is both nutritious and organoleptically desirable to the consumer at the same time that it provides a relatively high protein content so as to permit food formulators wider latitude in providing nutritious food products for a wider segment of the consumer food market. It will be further appreciated, therefore, that addition research and development to provide such flaked food material products is desirable to address these needs. The present invention provides products and methods for making these products which address these and other needs and solve other problems associated with the development of new flaked food materials for a variety of food products.

### SUMMARY OF THE INVENTION

The present invention provides a flaked food material including about 40 to about 95% by weight of a cereal flour, the cereal flour being selected from flours made from the group consisting of oats, wheat, corn, rice, barley, rye, amaranth and mixtures thereof; and about 5 to about 50% by weight of a soy protein isolate; the soy protein isolate having a viscosity of less than about 800 centipoise (CPS) when the protein isolate is mixed with de-ionized water at a concentration of at least about 8% protein and held at 25° C., as measured on a Brookfield viscosity meter by standard testing procedures known in the art. In preferred flaked food materials of the present invention, the soy protein isolate is at least partially hydrolyzed material so that the protein chain length of the individual protein molecules is reduced in a hydrolyzing process employed during or after isolation of the soy protein from soybeans. In alternate embodiments, the soy protein will demonstrate a low viscosity when tested in a “Stenzel meter” viscosity measurement procedure in which 60 grams of the soy protein isolate is combined with 300 mm of de-ionized water at room temperature, mixed and tested to see how viscous the mixture is by comparing the length of time it takes the mixture to slide 31 cms along the Stenzel meter. In preferred alternate embodiments, the soy protein isolate will slide this distance at least within seven seconds.

It is an object of the present invention to provide a flaked food material containing a cereal flour and a soy protein isolate, which, when combined, will provide a mixture of food materials which creates a limited resistance to extruder screws within a food processing extruder so that the torque created in response to the resistance of the food material in the extruder is minimized so that processing can continue with regularity and without interruption for shutdowns due to the high torque which is generally created when protein materials are included which have relatively long chain lengths. It is an object of the present invention to provide at least partially hydrolyzed soy protein isolates in which the chain lengths are at least somewhat shorter than they are in soy protein isolates which are not hydrolyzed.

It is a further object of the present invention to select the soy protein isolates used in the present invention by selecting those that have parameters that are believed to indicate that such soy protein isolates will offer less resistance to the screws turning within the extruders, so that the torque created within the extruder is minimized and processing can continue without unnecessary interruption. Although these parameters are not well established or well understood, it is believed, but not relied upon, that soy protein isolates having lowered viscosity ranges, based upon one of three alternate viscosity measurement procedures, will be sufficient to identify the soy protein isolates which will be preferred for use in the present flaked food material products.

It will be appreciated from the foregoing that the prior art flaked cereal products made for incorporation into various food products do not meet all the needs of the food industry and that further flaked food material products to satisfy all of the particular needs of the industry are needed to provide solutions for food formulators within the food industry. The present invention provides flaked food materials which will solve formulating difficulties and provide flaked food material products for use in a variety of food products and solve other problems and provide other solutions to problems faced by food formulators and manufacturers within the food industry.

### BRIEF DESCRIPTION OF THE DRAWINGS

Referring now to the drawings, in which like reference numerals refer to equivalent elements in the various embodiments of the present invention:

FIG. 1 is a schematic drawing of a pilot plant process flow chart for a process for extruding food material and producing flaked food material products of the present invention; and

FIG. 2 is a schematic drawing of a proposed production process flow chart for producing flaked food material products of the present invention.

### DETAILED DESCRIPTION OF THE PREFERRED EMBODIMENT

The present invention provides flaked food material products preferably including from about 10 to about 95% by weight of a cereal flour, preferably from about 2 to about 20% by weight of water, and preferably from about 5 to about 50% by weight of a soy protein.

In preferred embodiments, the cereal flour is produced from one or more of the following cereal grains: wheat, oats, corn, rice, rye, barley, amaranth and the like. In alternate embodiments, the cereal flour may be supplemented by substituting an at least partially pre-gelatinized starch for a portion of the cereal flour. A preferred at least partially pre-gelatinized starch is Crispioca, made from tapioca, although any other food grade pre-gelatinized or at least partially pre-gelatinized starch will be effective to supplement the cereal flour in this way. Preferred embodiments of the present invention will contain from about 5 to about 50% by weight of a soy protein isolate, preferably about 8 to about 40, more preferably about 10 to about 25, most preferably about 12 to about 20% by weight of the soy protein isolate.

In preferred embodiments, the soy protein isolate is at least partially hydrolyzed soy protein in which the soy protein is hydrolyzed either during isolation or subsequent to isolation in further processing of the soy protein isolate. In alternate embodiments, the preferred soy protein isolate will have a viscosity of less than 800, preferably less than 400 CPS at 25° C. at a shear rate of ten seconds on a Brookfield viscosity meter when the concentration of the soy protein isolate in de-ionized water is at least about 8%, preferably about 10%, more preferably about 12% and most preferably about 14%.

The present invention provides flaked food material products and processes for producing the same. The food material preferably includes from about 10 to about 95% by weight of a cereal flour, preferably from about 20 to about 95, more preferably from about 25 to about 95, even more preferably from about 35 to about 90, even more preferably from about 45 to about 85, and most preferably from about 60 to about 85% by weight of such a cereal flour. In preferred embodiments, the cereal flour is produced from one or more of the following cereal grains: wheat, oats, corn, rice, rye, barley, amaranth and the like.

In alternate embodiments, the cereal flour may be supplemented by substituting an at least partially pre-gelatinized starch for a portion of the cereal flour. A preferred at least partially pre-gelatinized starch is Crispioca, made from tapioca, although any other food grade pre-gelatinized or at least partially pre-gelatinized starch will be effective to supplement the cereal flour in this way.

The at least partially pre-gelatinized starch or pre-gelatinized starch is preferred because it will provide a more desirable product due to improved taste parameters. The present flaked food material products preferably include from about 5 to about 50, preferably from about 7 to about 35, more preferably from about 10 to about 20 percent by weight of such an at least partially pre-gelatinized starch material.

In addition, preferred embodiments of the present invention will contain at least about 5 to about 50% by weight of a soy protein isolate, preferably about 8 to about 40, more preferably about 10 to about 25, most preferably about 12 to about 20% by weight of the soy protein isolate. In preferred embodiments, the soy protein isolate is at least partially hydrolyzed soy protein in which the soy protein is hydrolyzed either during isolation or subsequent to isolation in further processing of the soy protein isolate. In all alternate embodiments, the soy protein will contain a plurality of protein molecules, at least 50% of which have been hydrolyzed in such isolation or subsequent processing, preferably at least about 70% and more preferably at least about 90% of such plurality of soy protein molecules have been hydrolyzed in such isolation and/or subsequent processing. In alternate embodiments, the preferred soy protein isolate will have a viscosity of less than 800, preferably less than 400 CPS at 25° C. at a shear rate of ten seconds on a Brookfield viscosity meter when the concentration of the soy protein isolate in de-ionized water is at least about 8%, preferably about 10%, more preferably about 12% and most preferably about 14%.

In preferred embodiments, the soy protein isolate is at least partially hydrolyzed. Preferred soy protein isolates include SUPRO® 760, SUPRO® 661, SUPRO® 610, SUPRO® HD90, SUPRO® 670, SUPRO® 710 and the like from DuPont Protein Technologies International, Inc., most preferably SUPRO® 710. It will be appreciated that other soy protein isolates having similar viscosity parameters may also be substituted and it will be further appreciated that other food grade protein isolates from other plant and animal sources are hereby included within the definition of soy protein isolates to the degree such protein isolates can be substituted for the preferred protein isolates and still provide an extrusion material that will adequately minimize the torque generated during the extrusion process. Examples of such isolates that are known to be available in the marketplace include whey protein isolates, milk protein isolates and the like.

In preferred embodiments, process water, preferably de-ionized water, will preferably be added at such a rate that the water in the food material in the extruder will be from about 5 to about 50, preferably from about 10 to about 45, more preferably from about 20 to about 40, even more preferably from about 25 to about 35 percent by weight of the food material in the extruder and the finished flakes, one the food material in the extruder is extruded, cut, rolled or flaked and then dried, will contain from about 2 to about 25, preferably from about 5 to about 20, more preferably from about 7 to about 15, even more preferably from about 9 to about 11 percent by weight of water in the final flaked food material product.

In alternate embodiments, the viscosity measurement may be made on a Stenzel meter using the following procedure. 60 grams of the soy protein isolate is combined with 300 ml of de-ionized water at room temperature. The soy protein isolate is mixed into the de-ionized water at a low speed (a speed setting of one) with a Hobart Kitchen-Aid mixer using a paddle for ten minutes and stopping after each two-minute interval to scrape down the sides of the mixing bowl. The mixture is then poured into a 100 ml beaker and the foam on top of the beaker is spooned off and discarded. The retained sample is poured into the Stenzel meter while holding a stopper at the mark. The cavity is filled to the top and the stopper is removed and the amount of time it takes the sample to flow to the end of the 31 cm mark on the Stenzel meter slide is measured by starting the stop watch when the stopper is removed and stopping the watch when the leading edge of the sample reaches the 31 cm mark. The preferred soy protein isolates, when evaluating using these viscosity measurement procedure, will preferably slide down to the 31 cm mark within a time period of 15 seconds or less of the time when the stopper is removed, preferably 12 seconds or less, more preferably ten seconds or less and most preferably seven seconds or less. In a further alternate test procedure, the same samples are evaluated in a standard Bostwick procedure. In this procedure, preferred soy protein isolates will measure 60 seconds or less, preferably 55 seconds or less, more preferably 50 seconds or less, and most preferably 47 seconds or less.

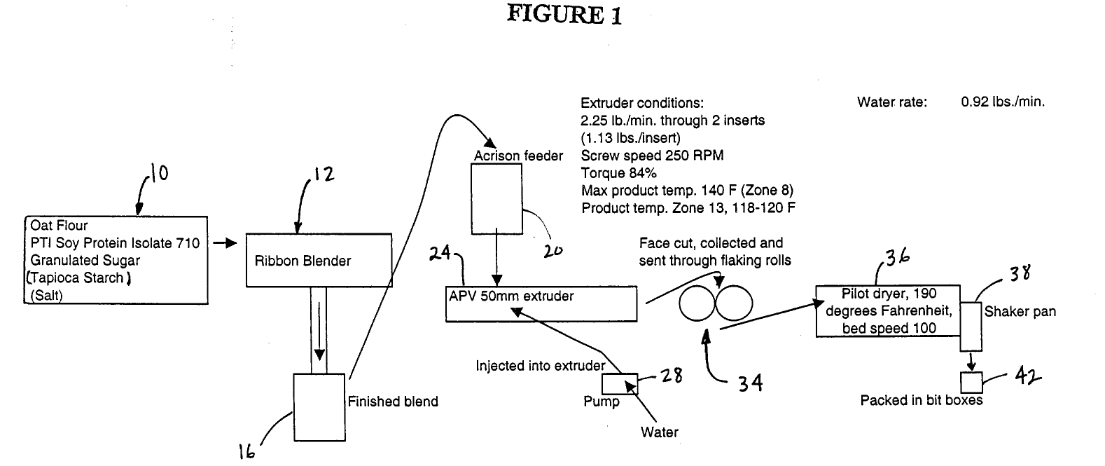

In alternate embodiments, the food material used to produce the flaked food material may also include sugar, preferably granulated sugar, a pre-gelatinized starch, preferably tapioca starch, and other products. Referring now to FIG. 1, the dry ingredients 10 are fed into a series of process devices in order to make the flaked food material. The dry ingredients 10 are first fed into a ribbon blender 12 where the dry ingredients are mixed. They are then allowed to fall into a hopper 16 where the finished blend is held for delivery to an Acrison feeder 20. The Acrison feeder 20 then feeds the dry ingredients into an APV, Incorporated 50 mm extruder 24 where the dry ingredients are mixed with process water injected into the extruder 24 by a pump 28. The extruder conditions preferably include the following: 2.25 pounds of dry ingredients per minute is fed into the extruder through two insert openings (1.125 pounds per minute through each insert opening (not shown)); screw speed is set at 250 rpms and the torque is 84%; the maximum product temperature is preferably 140° in Zone 8 and the product temperature at Zone 13, just prior to the extrusion face extruder is preferably about 118 to about 120° F. The water is injected at a rate of about 0.92 pounds per minute. When the food material is mixed with the water in the extruder and extruded through the extrusion face opening, the food material is face-cut, collected and send through a roller mechanism 34 and the material is flaked. The flaked food material is the passed through a pilot dryer preferably set at 190° F. at a bed speed of about 100. The flakes then fall into a shaker pan and are packaged in bit boxes.

In certain embodiments, the dry ingredients in the flaked food material include the following:

### EXAMPLE 1

### Soy Oat Flake 25% Protein

| | | Quantity | | | |
|---|---|---|---|---|---|
| Percentage (%) | Ingredients As Is | Pounds | | Grams | |
| 82.42 | Oat Flour (50 lb. bags) | 200.00 | lb | 90800.0 | g |
| 15.66 | PTI SPI 710 (44 lb. bags) | 38.00 | lb | 17252.0 | g |
| 1.92 | Sugar, granulated | 4.66 | lb | 2115.6 | g |
| 100.00 | | 242.66 | lb | | |

### EXAMPLE 2

### Soy Oat Flake 50% Protein

| | | Quantity | | | |
|---|---|---|---|---|---|
| Percentage (%) | Ingredients As Is | Pounds | | Grams | |
| 57.42 | PTI SPI 710 (44 lb. bags) | 150.00 | lb | 68100.5 | g |
| 41.61 | Oat Flour (50 lb. bags) | 108.70 | lb | 49348.2 | g |
| .97 | Sugar, granulated | 2.53 | lb | 1149.8 | g |
| 100.00 | | 261.23 | lb | | |

In each of these examples (Examples 1 and 2), the run screw speed was set at 250 rpms and the cutter speed was set at 1850 rpms and the feed setting was set at 460 (or 2.25 pounds of dry ingredients per minute). The dryer temperature was set at 190° F. and the bed speed was set at 100 and the water was injected at a water pump setting of 9.6, or at a rate of 0.91 pounds (419 grams) of water per minute. At this rate, the food material in the extruder will be 31.3 percent water prior to being extruded and then flaked. After the food material is extruded, cut, rolled or flakes and then dried, the resulting flaked food material products or soy oat flakes will have a moisture content of 10%. The following zone temperatures and product temperatures were also measured:

| | Zone | Product | Zone | Product |
|---|---|---|---|---|
| | Temperatures | Temperatures | Temperatures | Temperatures |
| Zone | Example 1 | Example 1 | Example 2 | Example 2 |
| Z5 | 102 | | 100 | |
| Z6 | 100 | | 100 | |
| Z7 | 108 | | 110 | |
| Z8 | 104 | 140 | 105 | 140 |
| Z9 | 104 | 131 | 105 | 130 |
| Z10 | 108 | — | 110 | — |
| Z11 | 94 | 117 | 95 | 118 |
| Z12 | 87 | 135 | 88 | 134 |
| Z13 | 80 | 118 | 82 | 120 |

In the following alternate embodiments, the dry ingredients in the flaked food material include the following:

### EXAMPLE 3

### Soy Oat Flake 25% Protein

| Percentage (%) | Ingredients As Is |
|---|---|
| 60.38 | PTI SPI 710 (44 lb. bags) |
| 22.45 | Oat Flour (50 lb. bags) |
| 13.54 | Crispioca (55 lb. bags) |
| 3.63 | Sugar, granulated |
| .99 | Salt |
| 100.00 | |

### EXAMPLE 4

### Soy Oat Flake 50% Protein

| Percentage (%) | Ingredients As Is |
|---|---|
| 60.38 | PTI SPI 710 (44 lb. bags) |
| 22.45 | Oat Flour (50 lb. bags) |
| 13.54 | Crispioca (55 lb. bags) |
| 3.63 | Sugar, granulated |
| .99 | Salt |
| 100.00 | |

In each of these examples (Examples 3 and 4), the run screw speed was set at 250 rpms and the cutter speed was set at 1850 rpms and the feed setting was set at 460 (or 2.25 pounds of dry ingredients per minute). The dryer temperature was set at 190° F. and the bed speed was set at 100 and the water was injected at a water pump setting of 9.6, or at a rate of 0.91 pounds (419 grams) of water per minute. At this rate, the food material in the extruder will be 31.3 percent water prior to being extruded and then flaked. After the food material is extruded, cut, rolled or flakes and then dried, the resulting flaked food material products or soy oat flakes will have a moisture content of 10%. The following zone temperatures and product temperatures were also measured:

| | Zone | Product | Zone | Product |
|---|---|---|---|---|
| | Temperatures | Temperatures | Temperatures | Temperatures |
| Zone | Example 3 | Example 3 | Example 4 | Example 4 |
| Z5 | 100 | | 100 | |
| Z6 | 100 | | 100 | |
| Z7 | 110 | | 110 | |
| Z8 | 105 | 140 | 105 | 140 |
| Z9 | 105 | 130 | 105 | 130 |
| Z10 | 110 | — | 110 | — |
| Z11 | 95 | 118 | 95 | 118 |
| Z12 | 88 | 134 | 88 | 134 |
| Z13 | 82 | 120 | 82 | 120 |

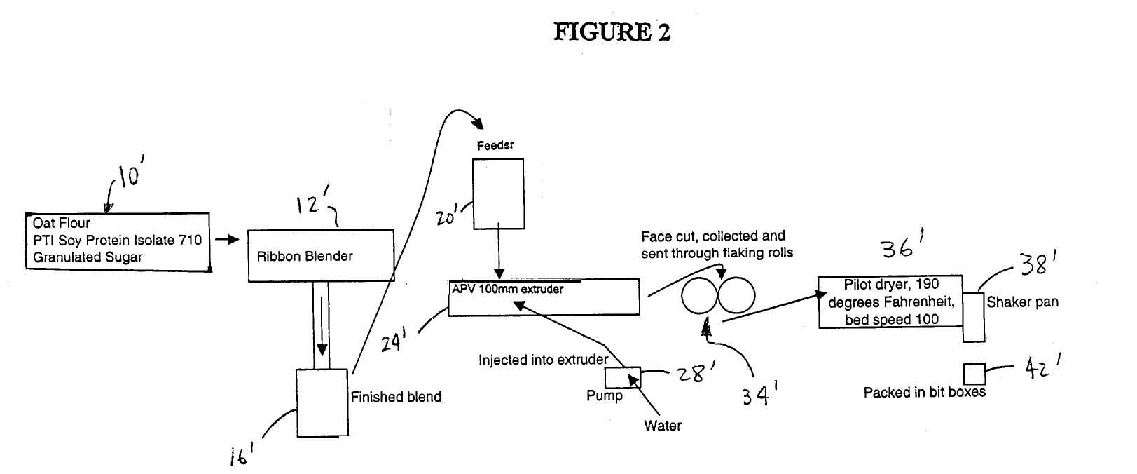

In further preferred embodiments prepared on a production line similar to that shown in FIG. 2, the dry ingredients in the flaked food material will include the following:

### EXAMPLE 5

### Soy Oat Flake—25% Protein

| Percentage (%) | Ingredients As Is | Quantity-Pounds | |
|---|---|---|---|
| 82.42 | Oat Flour (50 lb. bags) | 1236 | lb |
| 15.66 | PTI SPI 710 (44 lb. bags) | 235 | lb |
| 1.92 | Sugar, granulated | 29 | lb |
| 100.00 | | 1500 | lb |

### EXAMPLE 6

### Soy Oat Flake—50% Protein

| Percentage (%) | Ingredients As Is | Quantity-Pounds | |
|---|---|---|---|
| 57.42 | PTI SPI 710 (44 lb. bags) | 861 | lb |
| 41.61 | Oat Flour (50 lb. bags) | 624 | lb |
| .97 | Sugar, granulated | 15 | lb |
| 100.00 | | 1500 | lb |

As shown in FIG. 2, the production line includes an APV 100 mm extruder 24′ and is otherwise similar to the process line shown in FIG. 1.

In each of these examples (Examples 5 and 6), the run screw speed is set at 250 rpms and the cutter speed is set at 1850 rpms and the feed rate is 13.5 pounds of dry ingredients per minute. The dryer temperature is set at 190° F. and the bed speed is set at 100 and the water is injected at a rate of 5.46 pounds 2514 grams) of water per minute. At this rate, the food material in the extruder will be 31.3 percent water prior to being extruded and then flaked. After the food material is extruded, cut, rolled or flakes and then dried, the resulting flaked food material products or soy oat flakes will have a moisture content of 10%. The zone temperatures and product temperatures for these formulations are comparable to those for the prior examples.

The Soy Oat Flake (50% protein), described in Example 6, is available from Nuvex Ingredients, Inc., Blue Earth, MN under the product name Proti-Oats™ 50. Proti-Oats™ 50 rolled oats are used to make a number of products described in the Examples below. Other ingredients available for Nuvex Ingredients, Inc. are also used in these Examples, including Soy Crisp 50 and Apple NuChews™ food pieces.

### EXAMPLE 7

### Oat and Honey Granola Clusters 36

Procedure: Mix all liquid ingredients in beaker. Heat in microwave for 35 sec. Blend all dry ingredients using mixer (Kitchen Aid Heavy Duty). Slowly pour liquid ingredients into mixing bowl. Place material on cookie sheet and bake at 275 degrees F. for 18 min., stirring every 6 minutes. This product is 36.36 protein and contains 20 g of protein in a 55 g serving.

Desired batch size=200.00 lb.

| Percentage (%) | Ingredients | Quantity | |
|---|---|---|---|
| 45.8186 | Proti-Oats ™ 50 | 91.64 | lb. |
| 10.0811 | Soy crisp 50 | 20.16 | lb. |
| 6.0821 | Quick White Wheat Flakes | 12.16 | lb. |
| 4.3082 | almonds | 8.62 | lb. |
| 11.1505 | sucrose | 22.30 | lb. |
| 5.0684 | water | 10.14 | lb. |
| 3.0411 | corn syrup, high fructose | 6.08 | lb. |
| 5.0684 | Corn Syrup, 62 DE | 10.14 | lb. |
| 3.5479 | Kaomel | 7.10 | lb. |
| 1.8855 | N-lite | 3.77 | lb. |
| 1.8246 | honey | 3.65 | lb. |
| 0.7349 | N-Flate, National Starch | 1.47 | lb. |
| 0.7603 | molasses | 1.52 | lb. |
| 0.2230 | Meringue, Otten's 9132 | 0.45 | lb. |
| 0.2027 | salt | 0.41 | lb. |
| 0.2027 | cinnamon | 0.41 | lb. |
| 0.0000 | water | 0.00 | lb. |
| 100.00 | | 200.0 | lb. |

### EXAMPLE 8

### Oat and Honey Granola Clusters 23

Procedure: Mix all liquid ingredients in beaker. Heat in microwave for 35 sec. Blend all dry ingredients using mixer (Kitchen Aid Heavy Duty). Slowly pour liquid ingredients into mixing bowl. Place material on cookie sheet and bake at 275 degrees F. for 18 min., stirring every 6 min. This product is 23.64% protein and contains 13 g of protein in a 55 g serving.

Desired batch size=600.00 lb.

| Percentage (%) | Ingredients | Quantity | |
|---|---|---|---|
| 22.9093 | Proti-Oats ™ 50 | 137.46 | lb. |
| 22.9093 | rolled oats (original) | 137.46 | lb. |
| 5.0405 | Soy crisp 50 | 30.24 | lb. |
| 5.0405 | Rice Krispies ™ (from | 30.24 | lb. |
| | Kellogg) | | |
| 6.0821 | Quick White Wheat Flakes | 36.49 | lb. |
| 4.3082 | almonds | 25.85 | lb. |
| 11.1505 | sucrose | 66.90 | lb. |
| 5.0684 | water | 30.41 | lb. |
| 3.0411 | Corn Syrup, High Fructose | 18.25 | lb. |
| 5.0684 | Corn Syrup, 62 DE | 30.41 | lb. |
| 3.5479 | Kaomel | 21.29 | lb. |
| 1.8855 | N-lite | 11.31 | lb. |
| 1.8246 | honey | 10.95 | lb. |
| 0.7349 | N-Flate, National Starch | 4.41 | lb. |
| 0.7603 | molasses | 4.56 | lb. |
| 0.2230 | Meringue, Otten's 9132 | 1.30 | lb. |
| 0.2027 | salt | 1.22 | lb. |
| 0.2027 | cinnamon | 1.22 | lb. |
| 100 | | 600.0 | lb. |

### EXAMPLE 9

### Chewy Granola Bars

Procedure: Blend in beaker; pre-blend in mixer, then add liquid blend; add to mixture, heat to 150 F; add to mixture & blend; don't break Soy crisps; slab out and compress; cool and cut.

Desired batch size=250.00 g

| Percentage % | Ingredients As Is | Quantity |
|---|---|---|
| 22.53 | 62 DE corn syrup | 56.33 g |
| 3.90 | Glycerine | 9.74 g |
| 3.90 | HFCS 55% | 9.74 g |
| 1.16 | Sorbitol | 2.90 g |
| 0.31 | Flavor | 0.78 g |
| 7.59 | Brownsugar | 18.97 g |
| 0.10 | Lecithin | 0.26 g |
| 0.10 | Whey Protein Isolate | 0.26 g |
| 0.50 | Salt | 1.24 g |
| 1.4511 | Shortening | 3.63 g |
| 38.9718 | O & H Granola Clusters 36 | 97.43 g |
| 11.6086 | Soy Crisp 50 | 29.02 g |
| 7.8773 | Apple NuChews ™ | 19.69 g |
| | pieces | |
| 100.00 | | 250.0 g |

### EXAMPLE 10

### Oatmeal with Proti-Oats™ 50

Procedure: Mix up powdered blend in mixer. Set aside. Blend Proti-Oats 50, Quick Oats (from Quaker Oats) and Apple NuChews™ Pieces from Nuvex Ingredients, Inc. with designated amount of a powdered blend.

Desired batch size=35.00 g

| Percentage | | | | Powdered | 1 |
|---|---|---|---|---|---|
| % | Ingredients | Quantity | | Blend | (Multiple) |
| 32.30 | Proti-Oats 50 | 11.31 g | 66.470 | sugar | 66.47 g |
| 20.19 | Quick Oats | 7.07 g | 13.290 | maltodextrin | 13.29 g |
| | | | 1.660 | salt | 1.66 g |
| 13.70 | NuCHEWS | 4.79 g | 1.330 | Cal Carb | 1.33 g |
| | | | 1.000 | guar gum | 1.00 g |
| 33.82 | Powdered | 11.84 g | | | |
| | blend | | | | |
| 100.00 | | 35.00 g | | | 83.75 g |

To serve hot as a hot breakfast cereal like oatmeal, place blend in bowl. Add ⅓ cut water. Microwave at a high setting for 1 minute.

It is to be understood that even though numerous characteristics and advantages of the various embodiments of the present invention have been set forth in the foregoing description, together with details of the makeup of the flaked food material products of the present invention and the various steps of the method of making such flaked food material products, this disclosure is illustrative only and changes may be made in detail, especially in matters of additional constituents and/or steps in the process of making the various embodiments of the present invention, all within the principles of the present invention, to the full extent indicated by the broad general meaning of the terms in which the appended claims are expressed.

What is claimed is:

1. An extruded flaked food material in which low viscosity protein minimizes torque generated during extrusion processing, the flaked food material comprising:
a) from about 10 to about 95% by weight of a cereal flour;
b) from about 2 to about 20% by weight of water; and
c) from about 5 to about 50% by weight of a soy protein isolate; the soy protein isolate having a viscosity of equal to or less than about 800 CPS when the protein isolate is mixed with de-ionized water at a concentration of at least about 8% by weight of protein and held at 25° C.

2. The flaked food material of claim 1, wherein the soy protein isolate is at least partially hydrolyzed during or after isolation.

3. The flaked food material of claim 2, further comprising from about 5 to about 50% by weight of at least partially pre-gelatinized food grade starch.

4. An extruded flaked food material in which low viscosity protein minimizes torque generated during extrusion processing, the flaked food material comprising:
a) from about 10 to about 95% by weight of a cereal flour;
b) from about 2 to about 20% by weight of water; and
c) from about 5 to about 50% by weight of a soy protein isolate; the soy protein isolate having a viscosity of equal to or less than about 60 seconds in a Bostwick Viscosity measurement procedure.

5. The flaked food material of claim 4, wherein the soy protein isolate is at least partially hydrolyzed during or after isolation.

6. The flaked food material of claim 5, further comprising from about 5 to about 50% by weight of at least partially pre-gelatinized food grade starch.

7. An extruded flaked food material in which low viscosity protein minimizes torque generated during extrusion processing, the flaked food material comprising:
a) from about 10 to about 95% by weight of a cereal flour;
b) from about 2 to about 20% by weight of water; and
c) from about 5 to about 50% by weight of a soy protein isolate; the soy protein isolate having a viscosity of equal to or less than about 15 seconds in a Stenzel meter 31 cm slide test.

8. The flaked food material of claim 7, wherein the soy protein isolate is at least partially hydrolyzed during or after isolation.

9. The flaked food material of claim 8, further comprising from about 5 to about 50% by weight of at least partially pre-gelatinized food grade starch.

10. Oat containing clusters, comprising an extruded flaked food material in which low viscosity protein minimizes torque generated during extrusion processing, the flaked food material including:
a) from about 10 to about 95% by weight of a cereal flour;
b) from about 2 to about 20% by weight of water; and
c) from about 5 to about 50% by weight of a soy protein isolate selected from the group consisting of a soy protein isolate having a viscosity of equal to or less than about 800 CPS when the protein isolate is mixed with deionized water at a concentration of at least about 8% by weight of protein and held at 250 C; a soy protein isolate having a viscosity of equal to or less than about 60 seconds in a Bostwick Viscosity measurement procedure; a soy protein isolate having a viscosity of equal to or less than about 15 seconds in a Stenzel meter 31 cm slide test; and mixtures thereof.

11. A granola bar, comprising an extruded flaked food material in which low viscosity protein minimizes torque generated during extrusion processing, the flaked food material including:
a) from about 10 to about 95% by weight of a cereal flour;
b) from about 2 to about 20% by weight of water; and
c) from about 5 to about 50% by weight of a soy protein isolate selected from the group consisting of a soy protein isolate having a viscosity of equal to or less than about 800 CPS when the protein isolate is mixed with deionized water at a concentration of at least about 8% by weight of protein and held at 25° C.; a soy protein isolate having a viscosity of equal to or less than about 60 seconds in a Bostwick Viscosity measurement procedure; a soy protein isolate having a viscosity of equal to or less than about 15 seconds in a Stenzel meter 31 cm slide test; and mixtures thereof.
